(19) United States
(12) Patent Application Publication
(10) Pub. No.: US 2025/0255284 A1
(43) Pub. Date: Aug. 14, 2025

(54) OUTRIGGER MOUNT ASSEMBLY

(71) Applicant: Taco Metals, LLC, Miramar, FL (US)

(72) Inventor: Philip J. Serocki, Sparta, TN (US)

(21) Appl. No.: 19/049,439

(22) Filed: Feb. 10, 2025

Related U.S. Application Data
(60) Provisional application No. 63/551,808, filed on Feb. 9, 2024.

(51) Int. Cl. A01K 91/08

(52) U.S. Cl. CPC A01K 91/08

(57) ABSTRACT

An outrigger mount assembly includes a support member configured to receive an outrigger therein, wherein the support member is pivotable about a substantially horizonal axis between first and second positions, and wherein the support member is pivotable about a substantially vertical axis between third and fourth positions, an actuator assembly movable between a first configuration where the support member is movable between the first and second positions and is prevented from moving between the third and fourth positions, and a second configuration where the support member is movable between the third and fourth positions and is prevented from moving between the first and second positions, and a handle assembly movable between a first extended position causing the actuator assembly to move to the first configuration, a second extended position causing the actuator assembly to move to the second configuration, and a retracted position.

### CROSS-REFERENCE TO RELATED APPLICATIONS

This application claims benefit to U.S. Provisional Patent Application No. 63/551,808, filed Feb. 9, 2024, entitled “OUTRIGGER MOUNT,” the entire disclosure of which is incorporated herein by reference.

### BACKGROUND OF THE INVENTION

The present invention relates to an outrigger mount assembly, and in particular to an outrigger mount assembly configured to provide rotational and tilting adjustment of a supported outrigger via a highly adjustable and compact multiple-splined engagement arrangement, and additionally that provides locking of a supported outrigger within the outrigger mount assembly.

### SUMMARY OF THE INVENTION

One embodiment of the invention as shown and described herein includes an outrigger mount assembly that may include a support member configured to receive an outrigger therein, wherein the support member is pivotable about a substantially horizonal axis between first and second positions, and wherein the support member is pivotable about a substantially vertical axis between third and fourth positions, an actuator assembly movable between a first configuration where the support member is movable between the first and second positions and is prevented from moving between the third and fourth positions, and a second configuration where the support member is movable between the third and fourth positions and is prevented from moving between the first and second positions, and a handle assembly movable between a first extended position causing the actuator assembly to move to the first configuration, a second extended position causing the actuator assembly to move to the second configuration, and a retracted position.

Another embodiment as shown and described herein may further or alternatively include an outrigger mount assembly that may include a support member configured to receive an outrigger therein, wherein the support member is pivotable about a substantially horizonal axis between first and second positions, and wherein the support member is pivotable about a substantially vertical axis between third and fourth positions, and an actuator assembly movable between a first configuration where the support member is movable between the first and second positions and is prevented from moving between the third and fourth positions, and a second configuration where the support member is movable between the third and fourth positions and is prevented from moving between the first and second positions, wherein the actuator assembly includes a first spline arrangement that is engaged when the actuator assembly is in the first configuration and disengaged when the actuator assembly is in the second configuration.

Yet another embodiment as shown and described herein may further or alternatively include an outrigger mount assembly that may include a support member configured to receive an outrigger in an interior space of the support member, an engagement member movable between an engaged position where the engagement member is configured to prevent the outrigger from being removed from within the interior space of the support member, a disengaged position that allows the outrigger to be removed from the interior space of the support member, a locked position that prevents the engagement member from being moved from the second position to the first position, and an unlocked position that allows the engagement member to move from the disengaged position to the engaged position, and a biasing member that biases the engagement member from the second position toward the first position.

The embodiments of the outrigger mount assembly as shown and described herein provide a highly adjustable, compact and durable arrangement that can be easily operated and quickly adjusted by a single person, and is capable of a long operating life, and is particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of an outrigger mount assembly embodying the present invention;

FIG. 2 is an exploded perspective view of the outrigger mount assembly;

FIG. 3 is a side elevation view of the outrigger mount assembly showing an adjustment handle in a first extended position and a support member in a raised position;

FIG. 4 is a cross-sectional side elevation view of the outrigger mount assembly in the configuration shown in FIG. 3;

FIG. 5 is a side elevation view of the outrigger mount assembly with the adjustment handle in the first extended position and the support member in a lowered position;

FIG. 6 is a cross-sectional side elevation view of the outrigger mount assembly in the configuration shown in FIG. 5;

FIG. 7 is a side elevation view of the outrigger mount assembly showing the adjustment handle in a second extended position;

FIG. 8 is a cross-sectional side elevation view of the outrigger mount assembly in the configuration shown in FIG. 7;

FIG. 9 is a side elevation view of the outrigger mount assembly showing the adjustment handle in a storage or retracted position;

FIG. 10 is a cross-sectional side elevation view of the outrigger mount assembly in the configuration shown in FIG. 9;

FIG. 11 is an enlarged cross-sectional view of the area XI, FIG. 3;

FIG. 12 is a cross-sectional elevation view of an outrigger locking arrangement in an engaged position; and

FIG. 13 is a cross-sectional elevation view of the outrigger locking arrangement in a disengaged position.

### DETAILED DESCRIPTION OF PREFERRED EMBODIMENT

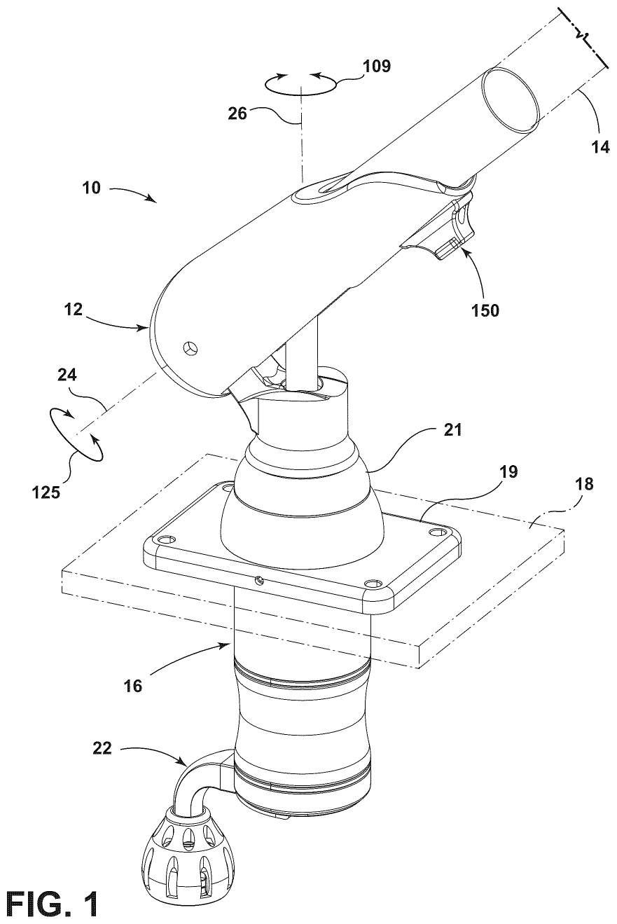

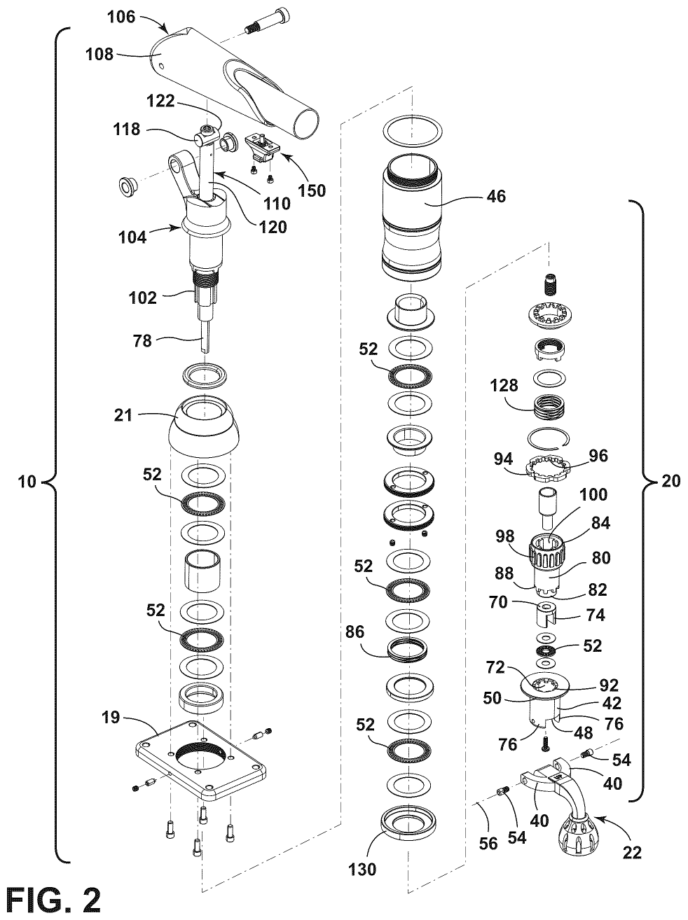

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

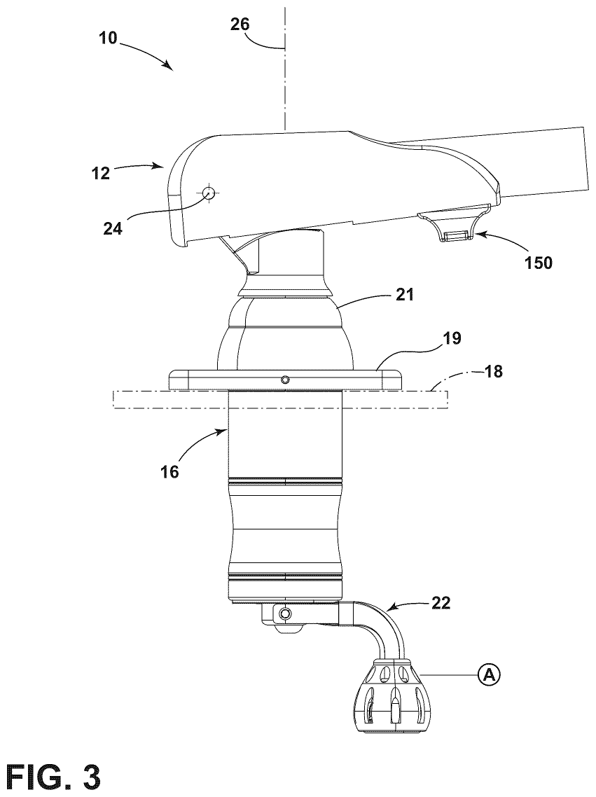

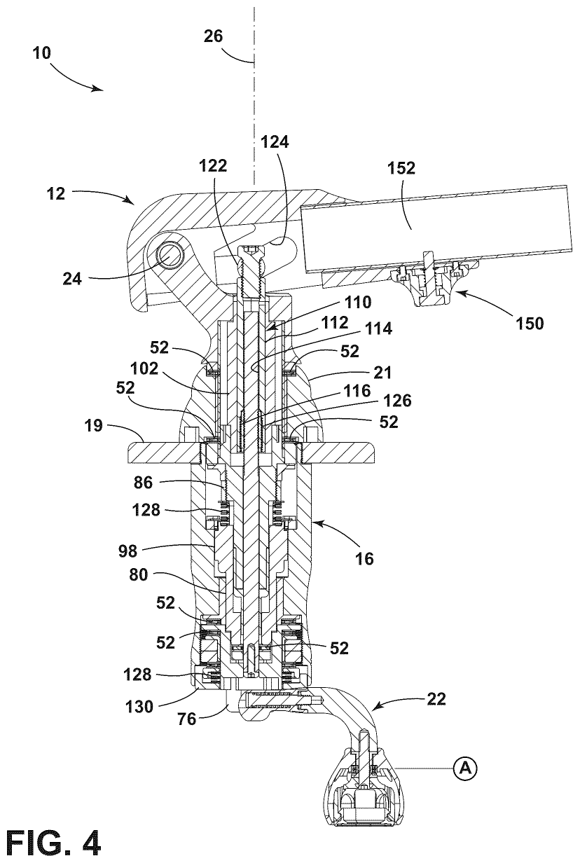

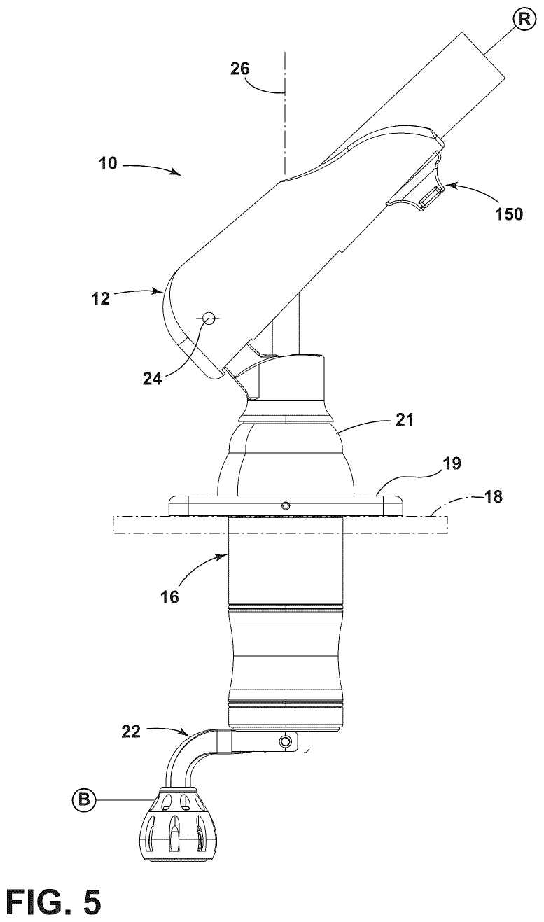

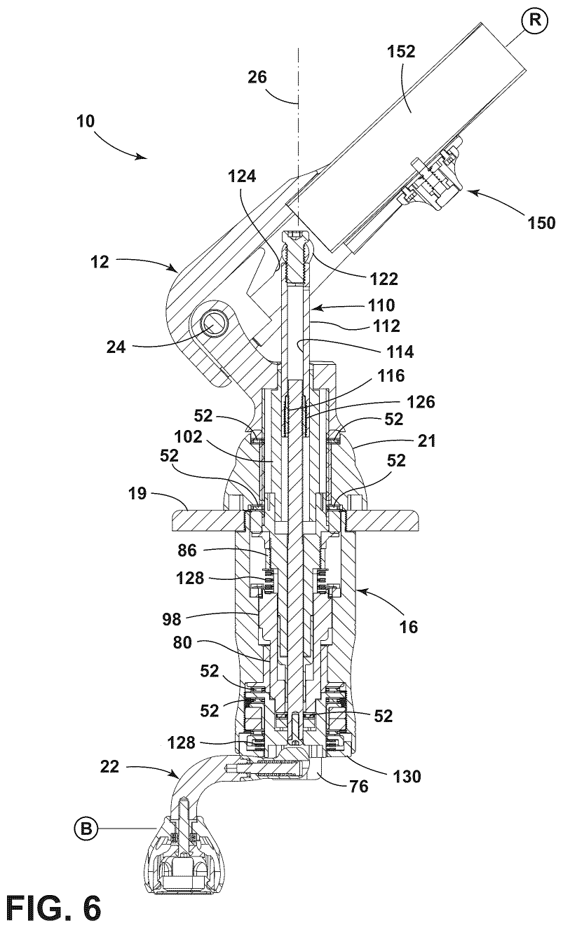

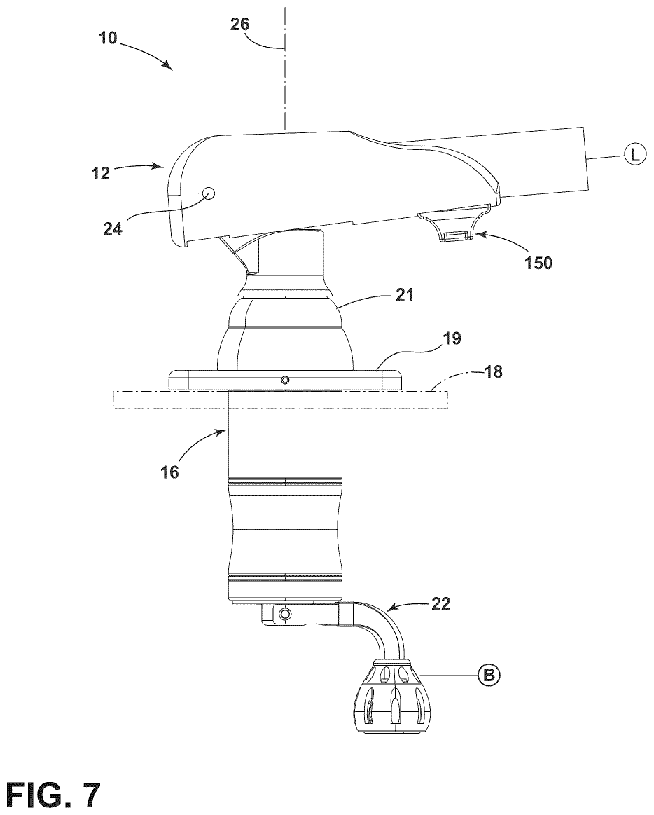

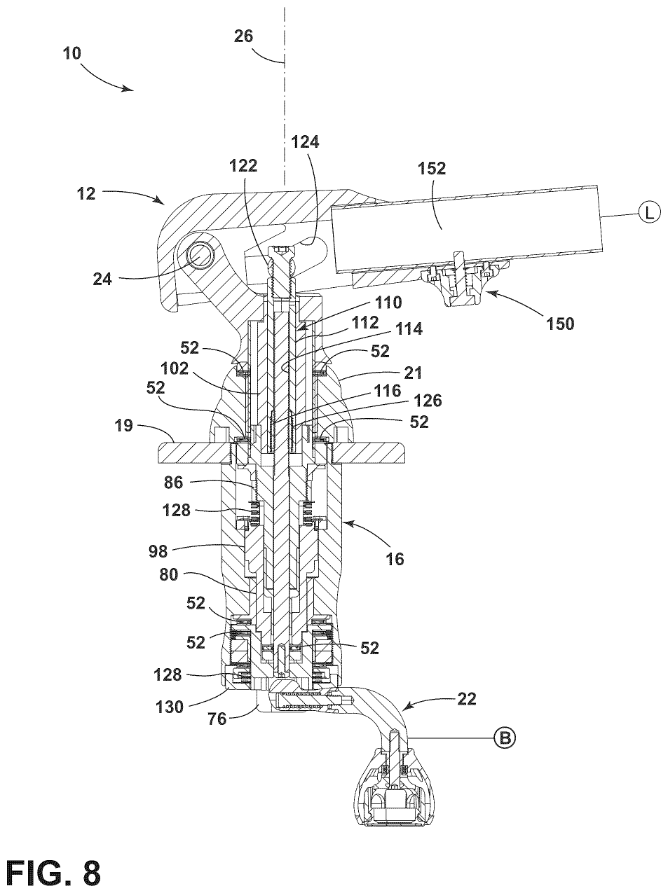

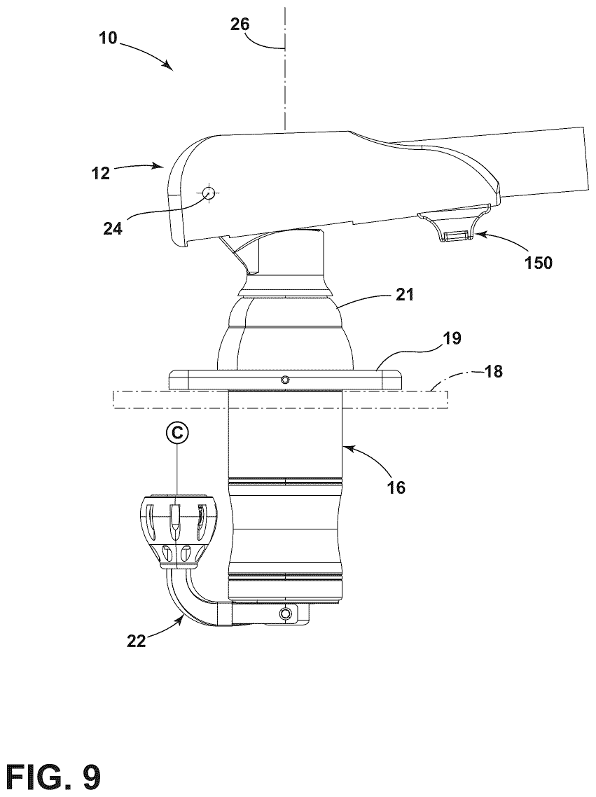

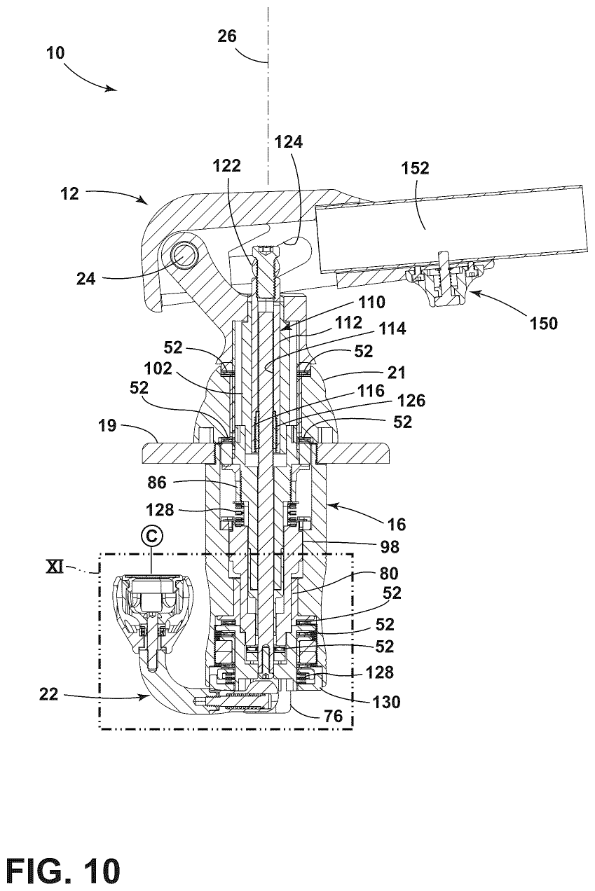

The reference numeral 10 (FIG. 1) generally designates an outrigger mount assembly embodying the present invention. In the illustrated example, the outrigger mount assembly 10 includes a head assembly 12 configured to removably support an outrigger 14 therein, a support assembly 16 configured to support the outrigger mount assembly 10 from a structure of a boat such as a boat T-top 18, and including an actuator assembly 20 (FIG. 2) configured to allow or prevent adjustment of the head assembly 12 about horizontal and vertical axes, and a handle assembly 22 adjustable between various actuation and storage positions. As further described in detail below, the handle assembly 22 is adjustable between: a first extended position A (FIGS. 3 and 4) such that rotation of the handle assembly 22 actuates the head assembly 12 about a vertical pivot axis 26; a second extended position B which moves the actuator assembly 20 to a second configuration such that rotation of the handle assembly 22 pivots the head assembly 12 about a horizontal pivot axis 24 between a raised position R (FIGS. 5 and 6) and a lowered position L (FIGS. 7 and 8); and a retracted or storage position C (FIGS. 9 and 10).

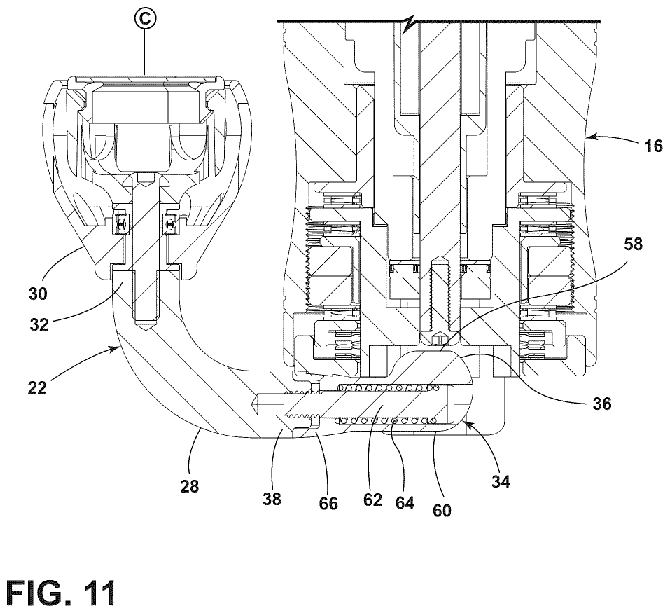

The handle assembly 22 (FIGS. 1, 2 and 11) includes a curved arm or lever 28, a knob/handle 30 rotatably coupled to a distal end 32 of the arm 28, and a cam member 34 with a cam surface 36 coupled to a proximate end 38 of the arm 28. The cam surface 36 is disposed between two mounting arms 40 that mount the handle assembly 22 to a race 42 located withing a housing 46 and which includes a slot 48 to receive the cam member 34. An upper end of the race 42 includes a shoulder 50 upon which one of a plurality of bearing sets 52 within the actuator assembly 20 are provided for rotation of the race 42 and handle assembly 22 where at least this lowermost bearing set 52 includes needle bearings. The mounting arms 40 are affixed to the race 42 by screws 54 that define a pivot axis 56 for the arm 28 and which allows the arm 28 to pivot to set the cam surface 36 on a high side or portion 58 of the cam surface 36 or a low side or portion 60 of the cam surface 60. As noted above, the handle assembly 22 has a multi-piece construction that allows the knob 30 to pivot into knob down first extended position A (FIGS. 3 and 4) and the knob down second extended position B (FIGS. 5-8) when the cam member 34 is pivoted. This arrangement permits the knob 30 to be in a user accessible location when the handle assembly 22 is in either the first extended position A or the second extended position B. As best illustrated in FIG. 11, the handle assembly 22 includes a screw 62 and a spring 64, where the proximate end 38 has a rectangular shape and a receiving end 66 of the cam member 34 has a mating rectangularly-shaped receptacle or recess 68 that allows seating of the proximate end 38 of the arm 28 within the recess 68 in positions that are 180° apart to position the knob 30 into the desired position without changing a position of the cam member 34.

A cylindrical cam follower 70 is disposed inside of a bore 72 of race 42 and includes a slot 74 formed therein, where the slot 74 defines two lobes 76 that are received in the race 42. The race 42 includes a segment that spans across an inner diameter thereof and divides the bore 72 into two portions that receive the lobes 76 therein when the cam follower 70 is inserted into the race 42. The segment has an aperture formed therein in which a lift rod 78 is fastened. The lift rod 78 is fastened to the race 42 and has a mating profile to the aperture profile in the segment of the race 78 and the lift rod 78 is fastened to the race 42 by a screw.

A rotation lock 80 is disposed coaxially with the cam follower 70 and the race 42. A first end 82 of the rotation lock 80 abuts against the cam follower 70 and an opposite second end 84 abuts a spring 86 that biases the rotation lock 80 into abutment with the cam follower 70. Next to the first end 82 of the rotation lock 80 is a shoulder 88 that includes a plurality of teeth 90 facing the race 42 where the race 42 has corresponding teeth 92 that face the rotation lock 80.

A locking ring 94 includes a spline 96 that is engaged to an outer spline 98 of rotation lock 80 when the handle assembly is in the first, extended position A and the high portion 58 of the cam surface 36 holds the rotation lock 80 in place, which allows a movement of the lift rod 78 relative to the rotation lock 80.

When the cam member 34 is set so the low side or portion 58 of the cam surface 36 is in contact with the cam follower 70 as shown in FIGS. 3 and 4, the spring 86 presses the teeth 90 of the rotation lock 80 into engagement with the corresponding teeth 92 on the race 42. The external splines 90 of the rotation lock 80 fall out of engagement with the splines 96 on the locking ring 94 such that the rotation lock 80 can rotate about the vertical axis 26. In this configuration, rotation of the handle assembly 22 about the vertical axis 26 rotates the race 42 and thus the rotation lock 80. The rotation lock 80 further includes an inner spline 100 that engages an outer spline 102 of the lower head assembly 104 of the head assembly 12 such that a rotation of the handle assembly 22 about the vertical axis 26 rotates the lower head assembly 104 via the race 42 and the rotation lock 80. This rotation of the lower head assembly 104 rotates an upper head assembly 106 of the head assembly 12 and thus rotates the outrigger pole 14 mounted within the support member 108 of the support assembly 16 in the directions 109 (FIG. 1).

A rod lift assembly 110 includes a shank portion 112 that has a bore 114 with female threads 116, and a T-shape head 118 defined by a cylindrical piece 120 that is affixed to an end of the shank portion 112. Ends 122 of cylindrical piece 120 engage in angled slots 124 in the upper head assembly 106 so that an axial motion of the rod lift assembly 110 adjusts a tilt angle of the head assembly 12 between the raised and lowered positions R, L.

When the cam member 34 is set so the high side or portion 60 of the cam surface 36 is in contact with the cam follower 70 as show in in FIGS. 5-8, the cam follower 70 presses the rotation lock 80 out of engagement with the race 42 and the outer spline 98 of the rotation lock 80 engages the spline 96 on the locking ring 94 which allows rotation of the cam follower 70 and the lift rod 78 relative to the rotation lock 80. The head assembly 12 is therefore not rotated during rotation of the handle assembly 22. The cylindrical piece 120 at the end of the rod lift assembly 110 is thus rotationally held as well. In this configuration, rotation of the handle assembly 22 about the vertical axis 26 causes the threads 126 of the lift rod 78 to rotate. Since the external threads 126 are engaged with the threads 116 on the rod lift assembly 110, which has the T-shape head 118 that rotationally holds the rod lift assembly 110, the threads 116, 126 move relative to one another. This in turn results in axial motion of the lift rod 78, which moves the cylindrical piece 120 in the angled slots 124 to tilt the upper head assembly 106 which adjusts an angular position of the upper head assembly 106 by pivoting the support member 108 about the horizontal axis 24 in the direction 125.

The handle assembly 22 may further be pivoted into the storage position C (FIGS. 9-11) where the handle 28 is folded upwardly and the knob 30 and at least a portion of the handle 28 extends upwardly from a lowermost end of the housing 16 and the actuator assembly 20, thereby reducing the chances of users accidentally contacting or colliding with the handle assembly 22.

A spring 128 is disposed within the race 42 and presses against a lower spring housing 120, which acts against the two arms 40 to hold the handle assembly 22 in place in the selected cam position. The ends of the mounting arms 40 are provided with a radius to allow smooth pivot between the high and low cam positions.

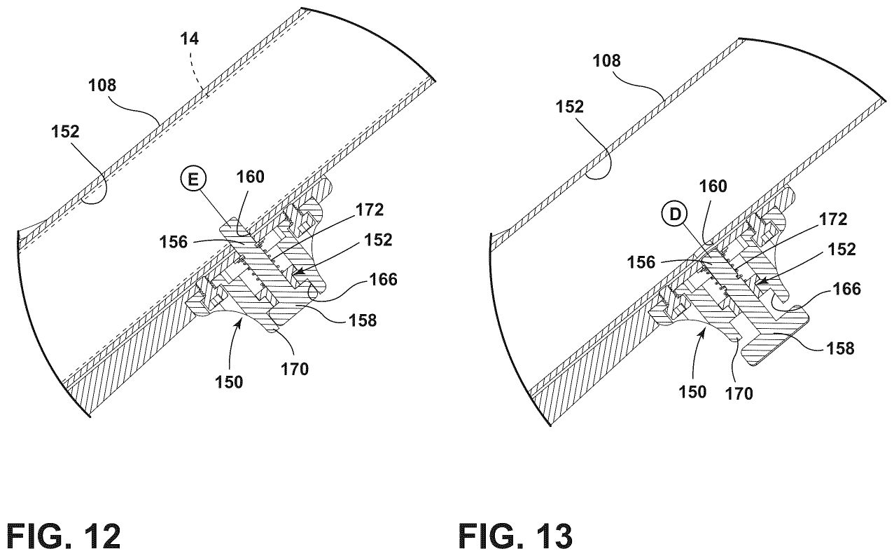

The outrigger mount assembly 10 may further include an outrigger locking arrangement 150 (FIGS. 12 and 13) configured to engage the outrigger 14 to prevent the outrigger 14 from being removed from within an interior 152 of the support member 108. In the illustrated example, the locking arrangement 150 includes a locking member 154 having a shaft portion 156 and a head 158, movable between an engaged configuration E (FIG. 12) where the shaft portion 156 extends through an aperture 160 of the support member 108 and the interior 152 and engages the outrigger 14 thereby preventing the outrigger 14 from being removed from the support member 108, and a disengaged configuration D (FIG. 13) where the shaft portion is withdrawn from within the interior 152 of the support member 108 and disengages the outrigger 14 thereby allowing the outrigger 14 to be removed from the support member 108. The locking arrangement 150 further includes a housing 162 secured to the support member 108 via a plurality of screws 164 and including a rectangularly-shaped recess 166 configured to receive the head 158 of the locking member when in the engaged configuration E, and an endwall 170, which the head 158 abuts when in the disengaged configuration D. A coil spring 172 biases the locking member toward the support member 108, which allows one-handed operation of the locking arrangement 150 by the user.

The above description is considered that of the preferred embodiment(s) only. Modifications of the invention will occur to those skilled in the art and to those who make or use the invention. Therefore, it is understood that the embodiment(s) shown in the drawings and described above merely are for illustrative purposes and not intended to limit the scope of the invention, which is defined by the following claims as interpreted according to the principles of patent law, including the doctrine of equivalents.

The invention claimed is:

1. An outrigger mount assembly, comprising:
a support member configured to receive an outrigger therein, wherein the support member is pivotable about a substantially horizonal axis between first and second positions, and wherein the support member is pivotable about a substantially vertical axis between third and fourth positions;
an actuator assembly movable between a first configuration where the support member is movable between the first and second positions and is prevented from moving between the third and fourth positions, and a second configuration where the support member is movable between the third and fourth positions and is prevented from moving between the first and second positions; and
a handle assembly movable between a first extended position causing the actuator assembly to move to the first configuration, a second extended position causing the actuator assembly to move to the second configuration, and a retracted position.

2. The outrigger mount assembly of claim 1, wherein the handle assembly extends downward from the actuator assembly when in the first and second extended positions, and wherein the handle assembly extends upwardly with respect at least a portion of the actuator assembly when in the retracted position.

3. The outrigger mount assembly of claim 1, wherein the actuator assembly is linearly actuated between the first and second configurations.

4. The outrigger mount assembly of claim 1, wherein the actuator assembly includes a first spline arrangement that is engaged when the actuator assembly is in the first configuration and disengaged when the actuator assembly is in the second configuration.

5. The outrigger mount assembly of claim 4, wherein the actuator assembly includes a second spline arrangement that is disengaged when the actuator assembly is in the first configuration and engaged when the actuator assembly is in the second configuration.

6. The outrigger mount assembly of claim 1, wherein the handle assembly includes a first cam surface that moves the actuator assembly to the first configuration when engaged, and a second cam surface that moves the actuator assembly to the second configuration when engaged.

7. The outrigger mount assembly of claim 1, wherein the actuator assembly includes a first biasing member that biases the actuator assembly toward the first configuration when the handle assembly is in the first extended position.

8. The outrigger mount assembly of claim 7, wherein the actuator assembly includes a second biasing member that biases the actuator assembly toward the second configuration when the handle assembly is in the second extended position.

9. An outrigger mount assembly, comprising:
a support member configured to receive an outrigger therein, wherein the support member is pivotable about a substantially horizonal axis between first and second positions, and wherein the support member is pivotable about a substantially vertical axis between third and fourth positions; and
an actuator assembly movable between a first configuration where the support member is movable between the first and second positions and is prevented from moving between the third and fourth positions, and a second configuration where the support member is movable between the third and fourth positions and is prevented from moving between the first and second positions, wherein the actuator assembly includes a first spline arrangement that is engaged when the actuator assembly is in the first configuration and disengaged when the actuator assembly is the in second configuration.

10. The outrigger mount assembly of claim 9, wherein the actuator assembly includes a second spline arrangement that is disengaged when the actuator assembly is in the first configuration and engaged when the actuator assembly is in the second configuration.

11. The outrigger mount assembly of claim 9, further comprising:
a handle assembly movable between a first extended position causing the actuator assembly to move to the first configuration, and a second extended position causing the actuator assembly to move to the second configuration.

12. The outrigger mount assembly of claim 11, wherein the handle assembly is further configured to move to a retracted position.

13. The outrigger mount assembly of claim 12, wherein the handle assembly extends downward from the actuator assembly when in the first and second extended positions, and wherein the handle assembly extends upwardly with respect to at least a portion of the actuator assembly when in the retracted position.

14. The outrigger mount assembly of claim 9, wherein the handle assembly includes a first cam surface that moves the actuator assembly to the first configuration when engaged, and a second cam surface that moves the actuator assembly to the second configuration when engaged.

15. The outrigger mount assembly of claim 9, wherein the actuator assembly includes a first biasing member that biases the actuator assembly toward the first configuration when the handle assembly is in the first extended position.

16. The outrigger mount assembly of claim 15, wherein the actuator assembly includes a second biasing member that biases the actuator assembly toward the second configuration when the handle assembly is in the second extended position.

17. An outrigger mount assembly, comprising:
a support member configured to receive an outrigger in an interior space of the support member;
an engagement member movable between an engaged position where the engagement member is configured to prevent the outrigger from being removed from within the interior space of the support member, a disengaged position that allows the outrigger to be removed from the interior space of the support member, a locked position that prevents the engagement member from being moved from the second position to the first position, and an unlocked position that allows the engagement member to move from the disengaged position to the engaged position; and
a biasing member that biases the engagement member from the second position toward the first position.

18. The outrigger mount assembly of claim 17, wherein the engagement member is pivotable between the locked and unlocked positions.

19. The outrigger mount assembly of claim 17, wherein the engagement member extends into the interior space when in the engaged position and is retracted from the interior space when in the disengaged position.

20. The outrigger mount assembly of claim 17, wherein the biasing member includes a coil spring.

21. The outrigger mount assembly of claim 17, wherein the engagement member is attached to an underside of the support member.

22. The outrigger mount assembly of claim 17, wherein the support member is pivotably supported by the support arrangement.
